(19) United States
(12) Patent Application Publication
(10) Pub. No.: US 2006/0157883 A1
(43) Pub. Date: Jul. 20, 2006

(54) Method for making prototype products

(76) Inventor: Fredrik Persson, Goteborg (SE)

Correspondence Address: FORD GLOBAL TECHNOLOGIES, LLC., FAIRLANE PLAZA SOUTH, SUITE 800, 330 TOWN CENTER DRIVE, DEARBORN, MI, 48126, US

(21) Appl. No.: 11/016,648

(22) Filed: Dec. 20, 2004

(30) Foreign Application Priority Data
Dec. 18, 2003 (EP) 03029126.4

(51) Int. Cl. B29C 39/42

(52) U.S. Cl. 264/102; 264/236; 264/225; 264/349

(57) ABSTRACT

The invention relates to a molded prototype product and a method for making such a molded product. The method includes the steps of providing a mold having a least a first mold section and a second mold section, assembling the mold sections into a mold assembly, which defines a mold cavity having the shape of the product to be molded and placing the mold assembly in a vacuum casting machine. The air is evacuated from the vacuum casting machine and a curable plastic material is mixed in the machine. The method also includes the steps of molding the mixed plastic material in the mold cavity in liquid form and curing the plastic material in the mold cavity. The cured molded product is then removed from the mold assembly.

### TECHNICAL FIELD

This invention relates to a method for making prototype products and products made by the method, and in particular, a method for making prototype products manufactured in short series for display and/or testing purposes.

### BACKGROUND ART

Manufacturing prototypes or early production models of a product for display and or testing purposes is usually a very costly and time consuming process. Such products are as a rule manufactured in relatively small series or lots, or even as a single unit, making them unsuitable for conventional manufacturing methods.

There are several rapid prototyping methods and devices suitable for making prototypes of this type, but the resulting products may not have the desired mechanical or material properties to allow them to be tested or used as desired.

One example of such products is automotive vehicle rims with three-dimensional deeply contoured ornamental discs or bodies. In production such rims are usually produced by deep drawing a flat steel plate to a desired profile. This profile is usually so deep that the wheel disc must be formed in several stages or press operations and it is sometimes necessary to anneal a disc between some of the drawing stages. Such severe drawing operations are also accompanied by relatively short die and tooling life. For these reasons, the deep drawing of ornamental wheel discs for prototyping purposes is a very expensive process. This is also true for the manufacture of alloy wheels, using aluminium or a similar relatively light metal. The tooling cost for making a mold for a short series of rims would be prohibitive.

Today prototype alloy wheel rims for testing and display are commonly milled from a solid aluminium block. The manufacture of a set of rims is still costly, although more reasonable than the above methods. It is also time consuming, as a set of four rims may take about ten weeks to complete, as each rim must be manufactured from scratch. There is a problem if one rims breaks during testing, as a replacement may not be immediately available. The resulting wheel rims will have material properties substantially equal to the production wheel rims, but are likely to be heavier as the design has not been optimized for casting.

It is a feature of the invention to provide a method for manufacturing prototype products and a prototype product, preferably, but not necessarily, manufactured by the inventive method, which product can be used for both display as well as for mechanical and functional testing purposes. By using the method of the invention, the problems related to lead time from design to a finished prototype may be reduced significantly. The unit cost is also lower when compared to the methods used in background art.

### SUMMARY OF THE INVENTION

It is therefore an object of the present invention to provide a prototype product and a method that solves the above problems. According to a preferred embodiment, the invention relates to a method for making a molded product, comprising the steps of:
providing a mold having a least a first mold section, a second mold section and at least on reinforcing insert, making up an attachment point for the product;
assembling the mold sections into a mold assembly, which defines a mold cavity having the shape of the product to be molded;
placing the mold assembly in a vacuum casting machine;
mixing components of a curable plastic material in liquid form in the vacuum casting machine;
molding the mixed plastic material in the mold cavity in liquid form;
removing the mold assembly from the vacuum casting machine;
curing the plastic material in the mold cavity; and
removing the cured molded product from the mold assembly.

The mold may be fabricated by covering a master model having the shape and dimensions of the product with a suitable material, for instance, silicone. The master model can be machined from a dimensionally stable block material, such as a ureol plastic material made by Cibatool.

When the silicone covering the master model has solidified it may be cut away from the master model and used to make a mold comprising at least two mold sections. Reinforcing inserts are positioned in the mold to strengthen local areas, which inserts form attachment means for cooperation with a corresponding securing means. Guide pins for facilitating re-assembly of the mold sections, or other additional guides, may be used for positioning the inserts in the mold cavity enclosed by the mold.

The mold sections are then assembled into a mold assembly and placed into a vacuum casting machine. The machine is provided with separate containers for at least two components and means for mixing the at least two components under vacuum conditions. The mixture containing the above components should be in a liquid form, allowing it to be poured into the mold assembly. By subjecting the component materials to vacuum before they are mixed until the mixture has been poured into the mold, any air or gases dissolved in these materials are extracted. This increases the strength of the molded product, as it is free from gas bubbles and porous areas.

According to one embodiment of the invention the two components may comprise a resin material and a hardener. One example of a suitable material for this purpose is a prepolymer material and hardener comprising a two component polyurethane.

According to a further embodiment of the invention the two components may comprise a prepolymer material, a hardener and a reinforcing material. It is possible to mix all components at one time, or to mix the prepolymer material with a pre-mixed material comprising a hardener and a reinforcing material.

Once the curable resin material has been filled into the mold, the casting machine may be pressurized. The mold can then be removed from the vacuum casting machine to allow the resin material in the filled mold to be cured. This is preferably, but not necessarily, achieved by placing it in an oven and heating the mold for a predetermined period of time.

One example of an apparatus for making a molded product using the above method comprises a vacuum casting machine having at least two chambers and means for creating a vacuum in the chambers such as a pump or a source of vacuum. The apparatus may further be provided with a first chamber with at least two containers for at least two components of a curable plastic material to be mixed before casting, a mixing means for mixing the materials before casting and a second chamber in which is placed a mold containing a mold cavity for receiving the mixed materials from the mixing means.

The first chamber may contain a first container for a resin material and a second container for a hardener. Alternatively, the second container may contain a mixture comprising a hardener and a reinforcing material. One of the first or the second container is provided a mixing device. The contents of the other container are poured into the container provided with the mixing device, wherein predetermined amounts of resin and hardener are mixed before molding. Alternatively the first container and the second container are both connected to a further container in a separate mixing unit, wherein predetermined amounts of resin and hardener are mixed before molding. In both cases the mixing operation occurs under vacuum conditions.

The above method allows prototypes to be manufactured and tested to a greater extent than what would otherwise be possible. This is due to the fact that the finished product can be given a higher strength than a conventional rapid prototype product, and yet be produced with a shorter lead time and at a lower cost than, for instance, machining a prototype from the material to be used in an actual product.

### BRIEF DESCRIPTION OF DRAWINGS

In the following text, the invention will be described in detail with reference to the attached drawings. These drawings are not drawn to scale, but are used for illustration only and do not in any way limit the scope of the invention. In the drawings:

FIG. 1 shows a schematic flow chart for the method according to the present invention.

### DETAILED DESCRIPTION OF THE PREFERRED EMBODIMENTS

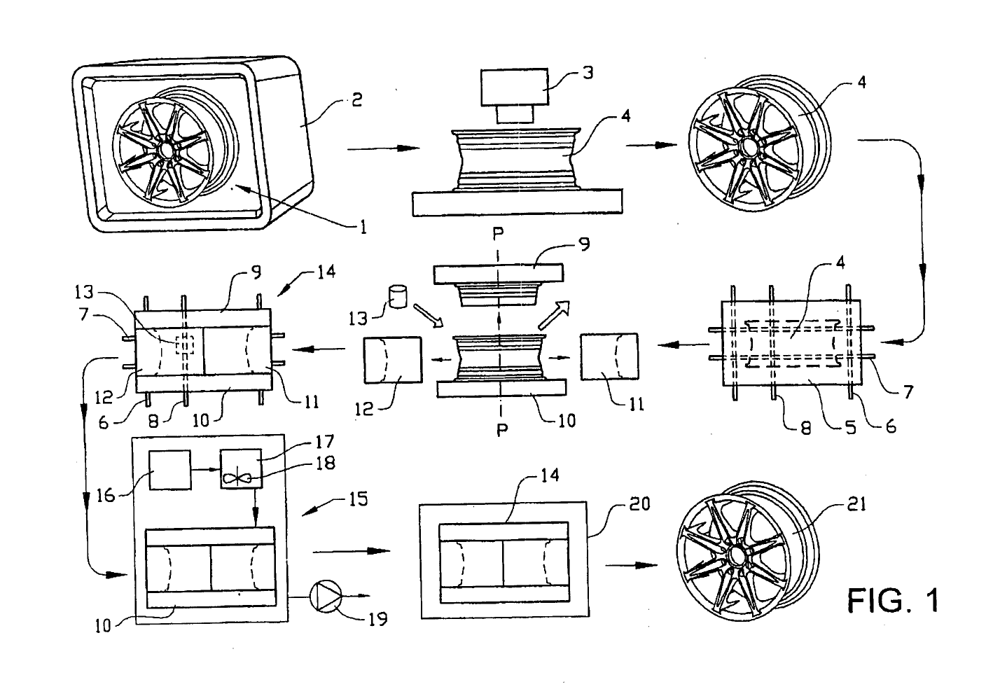

FIG. 1 shows a schematic flow chart for making a vehicle wheel rim using the method according to the invention. The method of the present invention can be used to make any of a number of different type components. The method of the present invention will be described herein for making a vehicle wheel rim, but the present invention is not meant to be limited to this application. A vehicle wheel rim is first designed by means of a computer aided design (CAD) program. The digital data representing the virtual CAD model 1 is transferred from a computer 2 to a numerically controlled (NC) machine 3, for the manufacture of a master model 4 to be used in the casting process. The master model can be machined from a dimensionally stable block material, such as a ureol plastic material made by Cibatool®. The master model 4 is machined to a dimensionally exact copy of the wheel rim and is given a surface treatment to produce a surface finish equal to that of a finished wheel rim. The latter operation entails filling in any remaining surface defects and painting the master model.

To make a mold 5, the master model 4, having the shape and dimensions of the wheel rim, is covered with a plastic resin, such as a silicone resin. Reinforcing inserts are positioned in the mold to strengthen local areas, which inserts form attachment means for cooperation with a corresponding securing means. Guide pins 6 for facilitating re-assembly of the mold sections, or other additional guides, may be used for positioning the inserts in the mold cavity enclosed by the mold. The inserts can be made from materials having a higher strength than the plastic material making up the major part of the finished product or prototype. Examples of such materials may be a metallic material, such as steel, titanium or aluminium. In this example, 20 guide pins made from steel rods having a diameter of 8-10 mm were used. One set of guide pins are positioned around the outer periphery of the wheel rim, parallel to the rotational axis P of the wheel rim, through the entire mold. These pins will position and hold the upper and lower mold sections 9, 10 together during the molding process. The upper and lower mold sections define the ornamental front and the rear of the wheel rim respectively. The mold sections are separated from a central part of the mold by upper and lower parting lines in a first and a second plane, which planes are at right angles to the rotational axis of the wheel rim and positioned adjacent the respective circumferential edges of the wheel rim. A further set of guide pins 7 are positioned at right angles to the axis and to a third plane defining a parting line between two mold sections 11, 12 enclosing the circular sections of the wheel rim. These pins will position and hold the two part-cylindrical mold sections 11, 12 together during the molding process. In addition, a number of guide pins 8 (only one indicated) are positioned axially through the mold in the exact locations of each of the wheel screws to be used for attaching the wheel rim to a vehicle. Each of the guide pins 8 are used to locate and hold a sleeve 13 that is molded into the wheel rim. The sleeves 13 can be made from steel, aluminium or a similar material and have a knurled outer surface for increasing the adhesion to the molded rim, and a conical inner surface for cooperation with a wheel screw. (not shown). This arrangement reduces the tension in the material in the area surrounding the wheel screw when the wheel rim is mounted.

When the silicone covering the master model has been cured, it may be cut away from the master model to make a mold comprising the above mold sections 9, 10, 11, 12.

When cutting the sections apart, the cut is preferably, but not necessarily, made slightly wavy. When re-assembling the mold section, the combination of the guide pins and the mating wave-cut surfaces will ensure that the sections are positioned correctly. In the figure indicating the separated section, the guide pins 6, 7, 8 have been removed for clarity.

The number of sections can be proportional to the degree of complexity of the design, undercuts and surface details of the finished product.

The mold sections are then assembled into a mold assembly 14 and placed into a vacuum casting machine 15. The machine is provided with separate containers 16, 17 for at least two components and means 18 for mixing the at least two components under vacuum conditions. In the current example, the containers can each hold 3-4 litres.

In a first embodiment of the present invention, the composition used for molding the wheel rim comprises a pre-polymer, a curative or hardener, a reinforcing fiber material and an optional antioxidant. The process first entails placing a prepolymer of polyurethane in liquid form in the first container 16. The fiber material is then added to a hardener in liquid form and placed in the second container 17. The containers 16, 17 and the mold assembly 14 are then placed in the vacuum casting machine 15 and connected by suitable means to enable the plastic material to be poured into the mold.

Once the air is evacuated and a vacuum has been established in the casting machine 15, the ingredients in the second container 17 are thoroughly mixed to form a first mixture. The prepolymer of polyurethane in the first container 16 is then added to the hardener in the second container 17 and is thoroughly mixed to form a homogeneous second mixture.

In the current example, the polyurethane is a transparent ureol polymer sold under the name SG95, made by MCP Heck©, mixed to the ratio 100/150 of prepolymer and curative, respectively. The fiber is ground glass fibers with a fiber length not exceeding 3 mm, making up 15% by weight of the mixture containing both components. Alternative fibers that may be used to reinforce the material includes flocked carbon fibers, having the same fiber length.

The vacuum is achieved by means of a pump 19 or another source of low pressure. The mixture containing the above components should be in a liquid form, allowing it to be poured into the mold assembly. By subjecting the component materials to vacuum for a predetermined period of time before they are mixed with any air, other gases or humidity dissolved in these materials or present in the ambient air are extracted. In the current example, this period of time is set at about 10 minutes. This deaeration and dehumidification increases the strength of the molded product, as it is free from gas bubbles and porous areas.

After the polyurethane elastomeric composition is prepared, the second mixture is poured from the second container 17 into the mold assembly 14. Once the mold cavity is filled and atmospheric pressure has been restored, the mold assembly is transferred to an oven 20 where the polyurethane elastomer is cured at a temperature of 70° C. for a period of 45 minutes.

In one alternate embodiment, an anti-oxidant and/or a hindered amine light stabilizer and/or an ultraviolet absorber are optionally added to the curative, or hardener. These chemical formulations assist in preventing deterioration of the finished product as a result of exposure to radiation from the sun and exposure to the atmosphere.

Depending on the starting materials, at least one of the above containers may be provided with heating means for melting the prepolymer material and/or the hardener. The container may be filled with a granulate material made of polyamide or a similar plastic material, with or without reinforcing fibers. In this case the heating element melts the granulate material under vacuum conditions, whereby the molten plastic is poured into the mold. As the molten plastic fills up the mold, the relatively low temperature of the walls of the mold will cause the molten plastic to solidify and to cure. The mold can then be taken out of the vacuum casting machine and the product can be removed from the mold without requiring further curing or heating. The mold itself may be reused for another 10-20 prototype products. For this type of materials, it may be necessary to pre-heat the mold assembly to prevent uneven solidification of the polyurethane elastomeric composition.

According to an alternative embodiment, the polyurethane elastomeric composition is fed into an injection manifold, where one or more of tubes lead from the injection manifold to corresponding injection ports in the mold assembly. The polyurethane elastomeric composition is then injected into the mold assembly. Depending on the starting materials, the low pressure may be released and the mold assembly removed, as described above, or the low pressure may be maintained until the polyurethane is cured.

The polyurethane elastomer is typically cured by exposure to a preselected, elevated temperature for a predetermined period of time. However, certain polyurethane formulations that may be used in the current invention do not require elevated temperature exposure, as they air cure at ambient, or room temperature.

In a second embodiment of the present invention only one of the containers in the vacuum casting machine is used, preferably the second container provided with a mixing means. The composition used is a polyamide granulate and an optional anti-oxidant. The composition is placed in, for instance, the second container and heated by a heating element (not shown) until melting occurs. The casting machine is connected to a source of vacuum and the composition is thoroughly mixed to form a homogenous liquid material. The molten composition is then poured from the second container into a preheated mold assembly. Once atmospheric pressure has been restored, the mold assembly is allowed to cool whereby the composition is simultaneously cured.

The finished product comprises a polyurethane or polyamide with added reinforcing fibers or particles, with local inner and/or outer structural reinforcements. Compared to a conventional method of prototyping rims, by milling each rim from a block of aluminium, the weight is reduced by approximately half and the cost by about 90% per unit for a set of four rims. Although made from a plastic material, such a wheel rim can be mounted on a vehicle and has sufficient strength to allow the vehicle to be driven. The wheel rims can not only be displayed, but also tested under actual driving conditions.

A set of wheel rims manufactured using the above method and apparatus was put through a test. The test cycle included 7 cycles, each comprising:
5 laps on a track for testing comfort at varying speeds, including a so-called “washboard” at 30 km/h and a simulated well cover at 50 km/h.
10 stop-and-go cycles from 0 to 30 to 0 km/h at a 0.45 g deceleration when braking.

The braking test is performed both straight ahead and in left/right-hand curves. Following these cycles, a final test included braking from 40 km/h using maximum braking force, two laps in a figure eight at 30 km/h, and a final lap on a life cycle track including running over a kerbstone at an angle. The total distance driven was 88 km. An ocular inspection showed no visible damage to the wheel rims.

The invention is not limited to the embodiments described above and may be varied freely within the scope of the appended claims. The above method may use such an apparatus for producing a wide range of products, in particular products having a complex geometry. One field where this is applicable is the automotive industry, where it is often desired to make pre-production prototypes of interior and exterior parts requiring a relatively high strength. Examples of such part may be wheel rims, advanced suspension parts, and interior trim. A further example may include cast speaker components, domes and horns. By providing local inserts of a material with higher strength where higher loads are placed on the product the overall strength of the product can be increased. Examples of such reinforcing inserts are metal sleeves for wheel screws in wheel rims and local reinforcements at or near attachment point for other automotive components.

What is claimed is:

1. A method for making a molded product, comprising the steps of:
providing a mold having a least a first mold section, a second mold section and at least one reinforcing insert, making up an attachment point for the product;
assembling the mold sections into a mold assembly, which defines a mold cavity having the shape of the product to be molded;
placing the mold assembly in a vacuum casting machine;
evacuating air from the vacuum casting machine;
mixing a curable plastic material in liquid form in the vacuum casting machine;
molding the mixed plastic material in the mold cavity in liquid form;
removing the mold assembly from the vacuum casting machine;
curing the plastic material in the mold cavity; and
removing the cured molded product from the mold assembly.

2. The method according to claim 1, wherein the step of providing the mold further includes the step of fabricating the mold by covering a master model having the shape and dimensions of the product with a plastic resin.

3. The method according to claim 2, wherein the step of fabricating the mold further includes the step of cutting the plastic resin from the master model to make a mold comprising at least two mold sections.

4. The method according to claim 2, wherein the step of fabricating the mold further includes the step of machining the master model from a block material and treating surface of the master model to produce a surface finish of a finished product.

5. The method according to claim 1, wherein the step of mixing a curable plastic material in liquid form further includes the step of mixing at least two components comprising a resin material, a hardener and a reinforcing material.

6. The method according to claim 5, further including the step of pre-mixing the hardener and ground glass fibers.

7. The method according to claim 1, wherein the step of mixing a curable plastic material in liquid form further includes the steps of heating and mixing a plastic material comprising curable plastic material into a homogenous liquid.

8. The method according to claim 7, wherein the plastic material comprises a polyamide granulate.

9. The method according to claim 1, wherein the step of curing the filled mold further includes the step of placing it in an oven and heating the mold for a predetermined period of time.
